(19) United States
(12) Patent Application Publication
(10) Pub. No.: US 2017/0343947 A1
(43) Pub. Date: Nov. 30, 2017

(54) FEED UNIT AND IMAGE FORMING APPARATUS THEREWITH

(71) Applicant: KYOCERA Document Solutions Inc., Osaka (JP)

(72) Inventor: Tomohide HOZONO, Osaka (JP)

(73) Assignee: KYOCERA Document Solutions Inc., Osaka (JP)

(21) Appl. No.: 15/597,877

(22) Filed: May 17, 2017

(30) Foreign Application Priority Data
May 24, 2016 (JP) 2016-103333

(51) Int. Cl. G03G 15/00

(52) U.S. Cl. CPC G03G 15/6502

(57) ABSTRACT

A feed unit stackable with another feed unit in the up-down direction includes a unit body and a storage cassette. The storage cassette has a cassette body in which a recording medium is stored, and is removably inserted in the unit body. The unit body has a positioning member projecting from its top face to serve to position another feed unit loaded on the feed unit. The storage cassette has a side cover forming a part of the exterior face of the feed unit. The side cover has a fitting part extending toward the top face of the unit body, and in the fitting part, an engagement recess is formed with which the positioning member engages so as to position the storage cassette relative to the unit body.

### INCORPORATION BY REFERENCE

This application is based upon and claims the benefit of priority from the corresponding Japanese Patent Application No. 2016-103333 filed on May 24, 2016, the entire contents of which are incorporated herein by reference.

### BACKGROUND

The present disclosure relates to a feed unit, and to an image forming apparatus provided with one. More particularly, the present disclosure relates to a feed unit including a storage cassette having a side cover forming part of the exterior face, and to an image forming apparatus provided with such a feed unit.

There are conventionally known image forming apparatuses comprising an image forming apparatus body and a plurality of tiers of feed units coupled to the image forming apparatus body under it. The feed units are composed of a unit body, which has formed in an upper part of it a positioning projection for positioning relative to the image forming apparatus body or another feed unit, and a storage cassette, which is removably inserted in the unit body. The storage cassette has a cassette body, in which sheets (recording medium) are stored, and a front cover (side cover), which forms part of the exterior face of the feed unit. On the front cover, a positioning projection is provided, and to the unit body, a positioning member is fitted which has a positioning recess in which the positioning projection is inserted. Thus, the front cover is positioned relative to the unit body via the positioning member.

### SUMMARY

According to a first aspect of the present disclosure, a feed unit is stackable with another feed unit in the up-down direction. The feed unit includes a unit body and a storage cassette. The storage cassette has a cassette body in which a recording medium is stored, and is removably inserted in the unit body. The unit body has a positioning member which projects from its top face and which positions the other feed unit loaded on the feed unit. The storage cassette has a side cover which is fitted to the cassette body and which forms a part of the exterior face of the feed unit. The side cover has a fitting part extending toward the top face of the unit body, and in the fitting part, an engagement recess is formed with which the positioning member engages so as to position the storage cassette relative to the unit body.

Further features and advantages of the present disclosure will become apparent from the description of embodiments given below.

### BRIEF DESCRIPTION OF THE DRAWINGS

FIG. 1 is a perspective view showing the structure of an image forming apparatus provided with a feed unit according to one embodiment of the present disclosure;

FIG. 2 is a perspective view showing the structure of the feed unit according to the one embodiment of the present disclosure;

FIG. 3 is a perspective view showing the structure of a unit body in the feed unit according to the one embodiment of the present disclosure;

FIG. 4 is a perspective view showing the structure of a storage cassette in the feed unit according to the one embodiment of the present disclosure;

FIG. 5 is a perspective view showing the structure around a positioning pin 12a in the unit body in the feed unit according to the one embodiment of the present disclosure;

FIG. 6 is a perspective view showing the structure around an engagement pin 12b in the unit body in the feed unit according to the one embodiment of the present disclosure;

FIG. 7 is a perspective view showing the structure around an engagement recess in the storage cassette in the feed unit according to the one embodiment of the present disclosure; and

FIG. 8 is a perspective view showing the structure around the engagement recess in the feed unit according to the one embodiment of the present disclosure.

### DETAILED DESCRIPTION

An embodiment of the present disclosure will be described below with reference to the accompanying drawings.

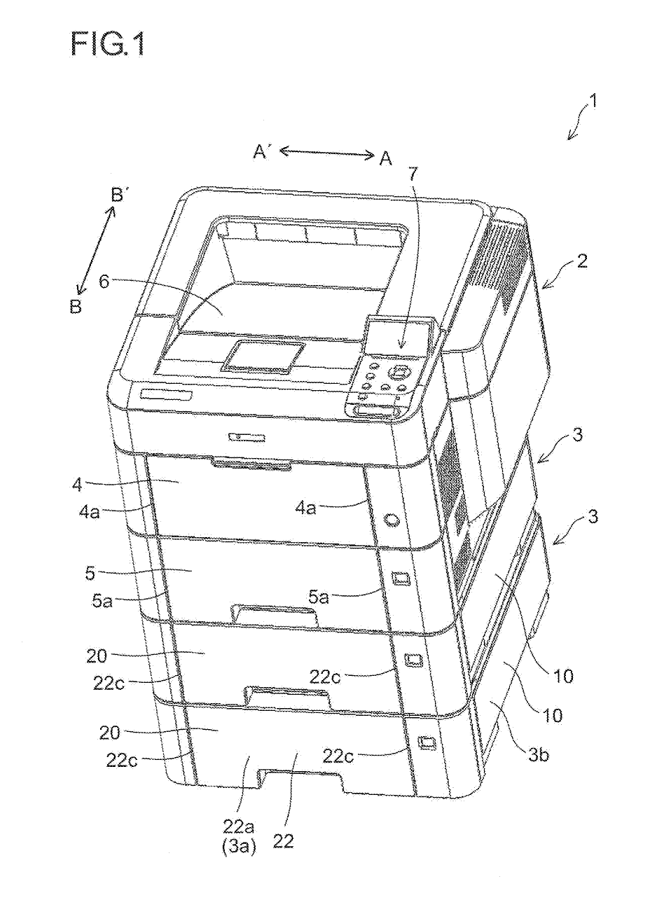

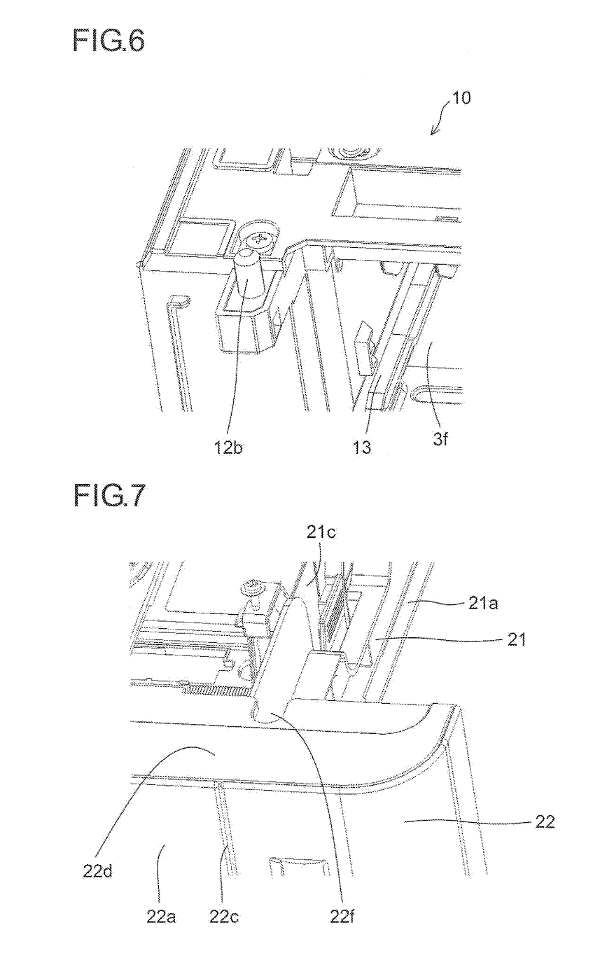

With reference to FIGS. 1 to 8, an image forming apparatus 1 according to one embodiment of the present disclosure will be described. As shown in FIG. 1, the image forming apparatus 1 is provided with an apparatus body (image forming apparatus body) 2 having a substantially hexahedral structure and one or more (here two) sheet feed units (feed units) 3 that can be stacked on each other under the apparatus body 2. In a front part of the apparatus body 2, which the user faces, there are provided a front cover 4, which is fitted to the apparatus body 2 so as to be openable and closable relative to it and which, when opened, serves as a hand feed tray, and a sheet cassette 5, which is detachably attached to the apparatus body 2. In an upper part of the apparatus body 2, there are provided a discharge tray 6, on which sheets (recording medium) are discharged, and an operation section 7, which includes a plurality of buttons and the like.

Inside the apparatus body 2, there are provided, though not illustrated, an image forming section, a fixing section, a sheet conveying passage, and the like. According to image data acquired from a host device such as a personal computer, the image forming section forms an image by transferring a toner image to a sheet fed to it. The image forming section includes a photosensitive drum for carrying an electrostatic latent image, a charging unit for electrostatically charging the surface of the photosensitive drum, an exposure unit for forming an electrostatic latent image corresponding to a document image on the surface of the photosensitive drum by use of a laser beam or the like, a developing device for forming a toner image by adhering developer to the so formed electrostatic latent image, a transfer roller for transferring the toner image to a sheet, a cleaning blade for removing the toner left behind on the surface of the photosensitive drum, and the like. The fixing section heats and presses the sheet having the toner image transferred to it, thereby to fix the toner image to the sheet. The image forming apparatus 1 does not necessarily have to be of a laser type, but may instead be of an ink-jet type.

Next, the structure of the feed unit 3 will be described in detail.

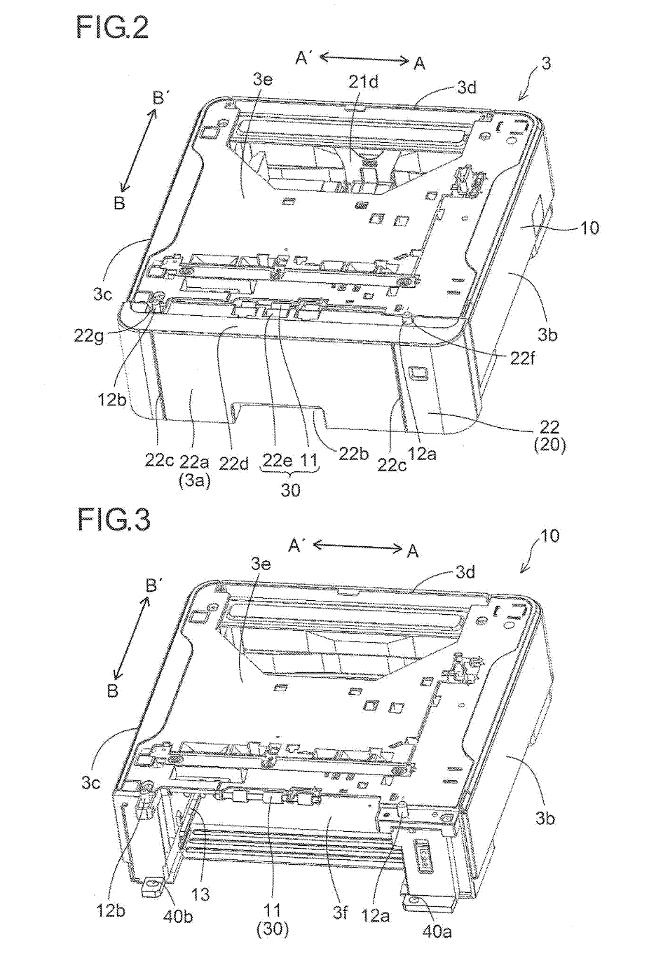

As shown in FIGS. 2 to 4, the feed unit 3 is composed of a unit body 10 and a storage cassette 20 which is detachably attached to the unit body 10.

As shown in FIG. 3, the unit body 10 is formed in the shape of a box open at the front face so as to form a right side face 3b, a left side face 3c, and a rear side face 3d of the feed unit 3 as seen from in front of it, and has a top plate 3e and a bottom plate 3f. In this embodiment, it is assumed that arrow A points rightward, arrow A′ points leftward, arrow B points frontward, and arrow B′ points rearward.

On the front side (in the arrow-B direction) of the unit body 10, in an upper part of a middle part of the unit body 10 in the sheet width direction (the arrows AA′-direction), there are provided a sheet feed device (unillustrated) for feeding out sheets stored in the storage cassette 20 and a plurality of conveying rollers 11 for feeding the sheets fed out from the sheet feed device to the image forming apparatus 1 or to a sheet feed unit 3 arranged in an upper tier.

As shown in FIGS. 3, 5, and 6, on the front side of the unit body 10, on the top face of both end parts of the unit body 10 in the sheet width direction, there are provided, at a predetermined interval from each other, a positioning pin (positioning member) 12a and an engagement pin (engagement projection) 12b that project upward. In a lower part of the body frame of the apparatus main body 2, and in a lower part of the unit body 10 of the sheet feed unit 3, there are provided a positioning hole 40a and an engagement hole 40b in which the positioning pin 12a and the engagement pin 12b are respectively inserted, the engagement hole 40b being an elongate hole extending in the arrows-AA′ direction. The positioning hole 40a and the engagement hole 40b in the unit body 10 are arranged to face, in the up-down direction, the positioning pin 12a and the engagement pin 12b respectively. Inserting the positioning pin 12a and the engagement pin 12b into the positioning hole 40a and the engagement hole 40b in the apparatus body 2 or in another sheet feed unit 3 permits the sheet feed unit 3 to be positioned relative to the apparatus body 2 or another sheet feed unit 3.

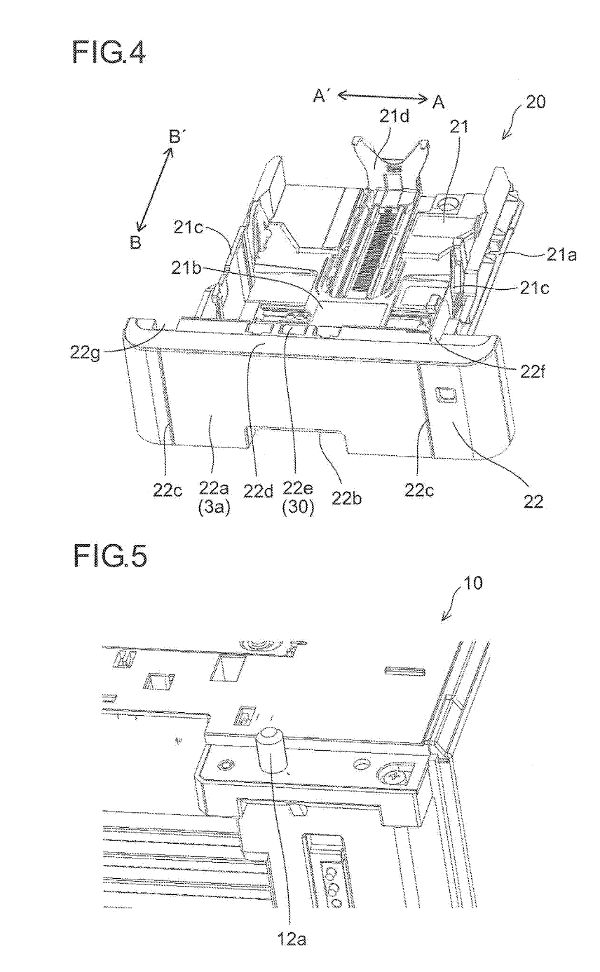

As shown in FIG. 4, the storage cassette 20 is composed of a cassette body 21 having a storage portion in which to store sheets and a front cover (side cover) 22 fastened to the cassette body 21.

In a lower part of side plates in both end parts of the cassette body 21 in the sheet width direction (the arrows-AA′ direction), there is provided a pair of sliding portions 21a which slides relative to rails 13 (see FIG. 3) provided inside the unit body 10. On the bottom face of the cassette body 21, there is provided a sheet placement plate 21b on which to place a stack of sheets. The sheet placement plate 21b is supported on the bottom face of the cassette body 21, with an end part of the sheet placement plate 21b on the upstream side (in the arrow-B′ direction) in the sheet feed direction as a pivot, and is swingable up and down, with an end part of the sheet placement plate 21b on the downstream side (in the arrow-B direction) in the sheet feed direction as a free end. The sheet placement plate 21b is a member in the shape of a plate, and has cuts formed in the movement regions of width restricting cursors 21c and a tail-end restricting cursor 21d, which will be described later.

Inside the cassette body 21, there is provided a pair of width restricting cursors 21c arranged upright along the sheet feed direction. The width restricting cursors 21c make contact with side faces of the sheet stack from both sides in the sheet width direction, and thereby position the sheets in their width direction. The pair of width restricting cursors 21c is configured such that, by the action of an interlock mechanism provided under it, when one is moved, the other moves simultaneously. In a middle part, in the sheet width direction, of the cassette body 21 on the upstream side in the sheet feed direction, there is provided a tail-end restricting cursor 21d. The tail-end restricting cursor 21d makes contact with a side face of the sheet stack from the upstream side in the sheet feed direction, and thereby positions the sheets in their feed direction.

The front cover 22 is fastened to a wall part of the cassette body 21 on the downstream side in the sheet feed direction. The front cover 22 is exposed to outside, and forms part of the exterior face of the sheet feed unit 3. In this embodiment, as shown in FIG. 2, the front cover 22 is formed to bridge from the front side face (first side face) 3a to the right side face (second side face) 3b and to the left side face (third side face) 3c of the sheet feed unit 3, and thus forms the front side face 3a, part of the right side face 3b, and part of the left side face 3c.

In a lower part of a middle part of the front face 22a (front side face 3a) of the front cover 22, a handle 22b is provided. The handle 22b is coupled to a shaft (unillustrated), which rotates as the handle 22b is operated, and hooks (unillustrated), which are provided in end parts of the shaft. The hooks are configured to protrude and retract in the arrows-AA′ direction, and are arranged to project outward in the arrows-AA′ direction. The hooks engage with engaged portions (unillustrated) in the shape of recesses formed in the left and right inner faces of the unit body 10, and thereby permit the storage cassette 20 to be positioned in the attachment-detachment direction (the arrows-BB′ direction).

In the front face 22a, on both the left and right sides of the handle 22b, there is provided a pair of vertical grooves 22c extending in the up-down direction for design purposes. As shown in FIG. 1, the grooves 22c are arranged to be continuous with, by being aligned with, grooves 4a and 5a formed in the front face of the sheet cassette 5 and grooves 22c in another sheet feed unit 3.

As shown in FIG. 4, the front cover 22 has a fitting part 22d which is formed integrally with the front face 22a and which extends toward a top plate 3e of the unit body 10. In a top part of a middle part of the fitting part 22d, there is provided a conveying roller 22e which together with the conveying rollers 11 constitutes a conveying member 30. The conveying roller 22e is arranged on the cassette body 21.

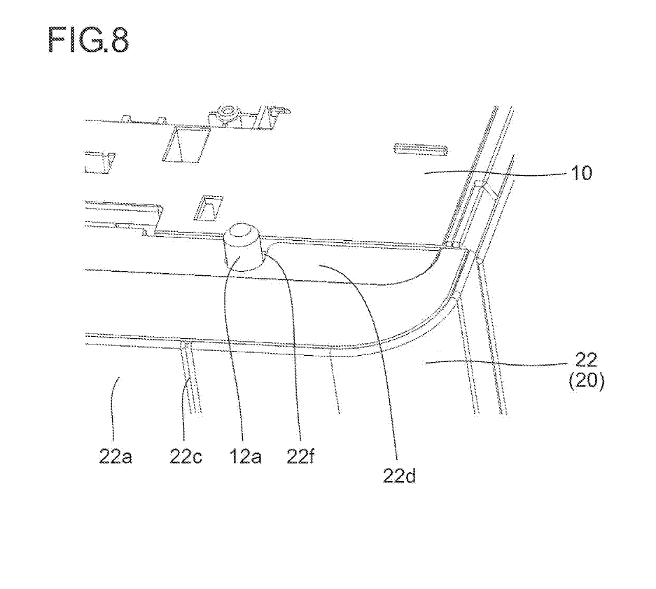

As shown in FIG. 4, in the fitting part 22d, on both the left and right sides of the conveying roller 22e, there are provided, at a position corresponding to the positioning pin 12a on the unit body 10, an engagement recess 22f and, at a position corresponding to the engagement pin 12b, a non-engagement recess 22g. As shown in FIGS. 7 and 8, the engagement recess 22f is formed in a U-shape, and engages with the positioning pin 12a so as to sandwich it in the left-right direction (the arrows-AA′ direction), thereby positioning the front cover 22 in the left-right direction (the direction parallel to the front cover 22). As shown in FIG. 2, the non-engagement recess 22g is formed in a rectangular shape larger than the engagement pin 12b, and does not make contact with the engagement pin 12b.

In the embodiment, as described above, on the fitting part 22d of the front cover 22, the engagement recess 22f is formed which engages with the positioning pin 12a on the unit body 10 and thereby positions the storage cassette 20 relative to the unit body 10. Thus, the front cover 22 can be positioned directly relative to the unit body 10, and this helps improve the positioning accuracy of the front cover 22 relative to the unit body 10. Furthermore, the positioning pin 12a serves to position the sheet feed unit 3 relative to the apparatus body 2 or another sheet feed unit 3, and with the positioning pin 12a, the front cover 22 can be positioned directly. This helps improve the positioning accuracy of the front cover 22 relative to the apparatus body 2 or another sheet feed unit 3. Thus, a plurality of tiers of front covers 22 can be aligned accurately in the sheet width direction (the arrows-AA′ direction). As a result, for example, even in a case where the vertical grooves 22c are provided in a plurality of tiers of front covers 22 for design purposes, or in a case where vertical grooves 4a and 5a are provided in the apparatus body 2, it does not occur that the vertical grooves 22c, 4a, and 5a are staggered in the sheet width direction and spoil the appearance of the image forming apparatus 1.

Moreover, the cassette body 21 is positioned with the positioning pin 12a via the front cover 22; this helps improve the positioning accuracy of the cassette body 21, and helps suppress a displacement of sheets in their width direction.

Moreover, as described above, in a case where the front cover 22 forms parts of the right and left side faces 3b and 3c, a displacement of the front cover 22 in the left-right direction causes the front cover 22 to protrude and retract from the right and left side faces 3b and 3c. Seeing that such irregularities are conspicuous when seen from in front, applying the present disclosure in a case where the front cover 22 forms parts of the right and left side faces 3b and 3c to suppress a displacement of the front cover 22 in the left-right direction is particularly effective.

Moreover, as described above, in the fitting part 22d of the front cover 22, the non-engagement recess 22g is formed so as not to make contact with the engagement pin 12b. Thus, the engagement pin 12b can be prevented from making contact with the front cover 22; thus, with the positioning pin 12a and the engagement recess 22f, the front cover 22 can be positioned easily and accurately in the sheet width direction.

Moreover, as described above, the conveying member 30 is arranged on or near the front cover 22. That is, the positioning pin 12a and the engagement pin 12b are provided toward an end part on the downstream side of the sheet feed direction (an end part in the arrow-B direction). This helps suppress a displacement of sheets, in particular, a tip part of them, and helps more effectively suppress a displacement of sheets in the width direction (the arrows-AA′ direction) during conveying.

The embodiments disclosed herein should be understood to be in every respect illustrative and not restrictive. The scope of the present disclosure is not defined by the description of embodiments given above but by the appended claims, and encompasses any modifications made in the sense and scope equivalent to those of the claims.

For example, although the above description deals with an example where the present disclosure is applied to a printer, this is not meat to limit the application of the present disclosure. Needless to say, the present disclosure find applications in a variety of image forming apparatuses provided with a feed unit, such as copiers and digital multifunction peripherals.

What is claimed is:

1. A feed unit stackable with another feed unit in an up-down direction, comprising:
a unit body; and
a storage cassette having a cassette body in which a recording medium is stored, the storage cassette being removably inserted in the unit body,
wherein
the unit body has a positioning member projecting from a top face of the unit body, and the positioning member positions the another feed unit loaded on the feed unit,
the storage cassette has a side cover fitted to the cassette body, the side cover forming a part of an exterior face of the feed unit,
the side cover has a fitting part extending toward the top face of the unit body,
in the fitting part, an engagement recess is formed with which the positioning member engages so as to position the storage cassette relative to the unit body.

2. The feed unit of claim 1, wherein
a positioning hole is formed on a lower part of the unit body, and when the another feed unit is mounted under the feed unit, the positioning hole is able to engage with a positioning member on the another feed unit.

3. The feed unit of claim 1, wherein
an engagement projection is formed in an upper part of the unit body and arranged at a predetermined interval from the positioning member,
an engagement hole is formed in a lower part of the unit body and arranged to face the engagement projection, and
the engagement hole is an elongate hole that allows the engagement projection to move in a major-axis direction thereof.

4. The feed unit of claim 1, wherein
the exterior face includes a first side face on a downstream side of the storage cassette in an extraction direction thereof and second side faces extending in the extraction direction, and the side cover constitutes the first side face and part of the second side faces.

5. The feed unit of claim 3, wherein
in the fitting part of the side cover, a non-engagement recess is formed so as not to make contact with the engagement projection.

6. The feed unit of claim 1, further comprising:
a conveying member for conveying the recording medium from the storage cassette to the another feed unit, wherein
the conveying member is arranged on the cassette body near the side cover.

7. An image forming apparatus, comprising:
the feed unit of claim 1;
an apparatus body in which the feed unit is mounted; and
an image forming section provided inside the apparatus body, for forming an image on the recording medium.
